(19) United States
(12) Patent Application Publication
(10) Pub. No.: US 2007/0204926 A1
(43) Pub. Date: Sep. 6, 2007

(54) System and method for controlling fluid flow in a microfluidic circuit

(76) Inventors: Timothy Beerling, San Francisco, CO (US); Reid Brennen, San Francisco, CA (US); Hongfeng Yin, Cupertino, CA (US); Ronald Shane Fazzio, Loveland, CO (US); Kevin Killeen, Woodside, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/366,197

(22) Filed: Mar. 2, 2006

(51) Int. Cl. F15C 1/04

(52) U.S. Cl. 137/828

(57) ABSTRACT

A system for controlling fluid flow in a microfluidic circuit includes at least one microfluidic channel, and a heating element adjacent the at least one microfluidic channel, wherein when activated, the heating element boils liquid in the at least one microfluidic channel.

### BACKGROUND

A liquid chromatograph is one example of a device in which it is desirable to control the flow of one or more fluids using a microfluidic circuit. In liquid chromatography, a sample liquid is passed through what is referred to as a “packed column.” The packed column contains material that is referred to as the “stationary phase.” As the liquid passes through the packed column, the stationary phase impedes the movement of the liquid such that different materials that are contained in the liquid sample pass through the packed column at different rates and elute from the packed column at different times. The material eluting from the packed column can be identified by measuring the elution time of each material. The output of the packed column is typically directed to an outlet channel for injection into a detector.

It is desirable to maintain a constant flow of fluid to the outlet channel of the column. The flow rate through the column depends on the pressure gradient across the column and on the nature of the sample fluid. For example, the viscosity of the sample fluid may change during the course of a single analysis. This causes the fluidic impedance of the column and possibly other parts of the fluidic circuit to change. The change in fluidic impedance causes an undesirable change in the flow rate through the outlet channel of the column.

### SUMMARY OF THE INVENTION

In accordance with the invention, a system for controlling fluid flow in a microfluidic circuit includes at least one microfluidic channel, and a heating element adjacent the at least one microfluidic channel, wherein when activated, the heating element boils liquid in the at least one microfluidic channel. When boiled, the liquid forms a bubble in the microfluidic channel. The bubble impedes the flow of liquid in the microfluidic channel, thus modulating and thereby controlling the flow of liquid in the microfluidic channel.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an electrical circuit representation of a fluidic circuit.

FIG. 2A is a schematic diagram illustrating a fluidic circuit.

FIG. 2B is a schematic diagram illustrating the fluidic circuit of FIG. 2A in which fluid flow is controlled by the heating elements.

FIG. 3A is a schematic diagram illustrating a cross-sectional view of the fluid cavity of FIG. 2A and FIG. 2B.

FIG. 3B is a schematic diagram illustrating a cross-sectional view of the fluid cavity of FIG. 3A after generation of a bubble.

FIG. 4A is a detailed schematic diagram illustrating a cross-sectional view of the fluid cavity of FIG. 2A and FIG. 2B.

FIG. 4B is a detailed schematic diagram illustrating a cross-sectional view of the fluid cavity of FIG. 4A after generation of a bubble.

FIG. 5 is a flowchart describing a method for controlling fluid flow in a microfluidic circuit.

### DETAILED DESCRIPTION

The system and method for controlling fluid flow in a microfluidic circuit employs a heater located in the microfluidic circuit. When activated, the heater boils liquid in a microfluidic channel in the vicinity of the heater and causes a bubble to form in the microfluidic channel. The bubble impedes fluid flow in the microfluidic channel, thus modulating, and thereby controlling, the flow of fluid in the microfluidic channel. Although described for use in controlling the flow of liquid in a liquid chromatograph, the system and method for controlling fluid flow in a microfluidic circuit can be used to control fluid flow in any microfluidic circuit.

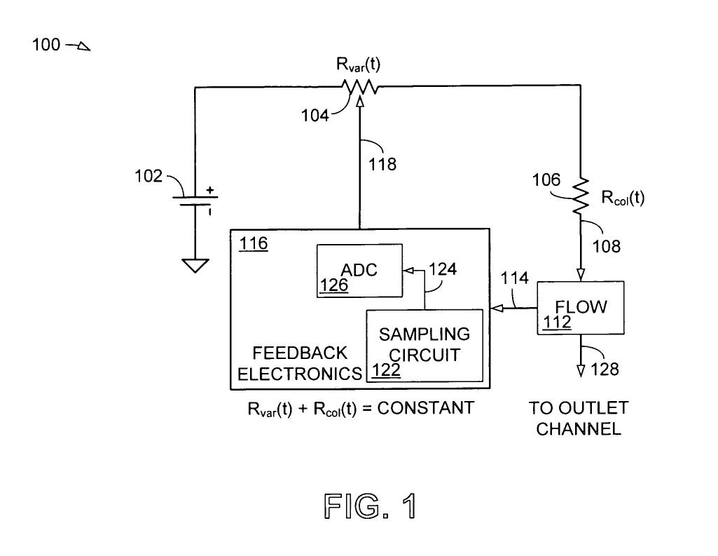

FIG. 1 is a schematic diagram illustrating an electrical circuit representation 100 of a fluidic circuit. The electrical circuit representation comprises a pressure source 102, which is schematically illustrated as a voltage source. The pressure source 102 is coupled to a variable fluidic impedance 104, which is represented as a variable resistance. The variable fluidic impedance 104 can be electrically represented as Rᵥₐᵣ(t). The variable fluidic impedance 104 is coupled to a column 106, which is schematically illustrated as a fixed resistance. In an embodiment, the column 106 could be a packed column used in liquid chromatography. The column 106 can be electrically represented as R_{col}(t), where R_{col} is the resistance through the column. The output of the column 106 is coupled to a flow sensor 112. The flow sensor 112 monitors the flow of fluid through the column 106 and provides a flow signal to the feedback electronics 116 via connection 114. The output of the flow sensor on connection 128 is directed to, for example, the output channel of a liquid chromatograph.

The feedback electronics 116 comprises a sampling circuit 112 that samples the output of the flow sensor 112 on connection 114. The sampling circuit 122 provides an analog signal over connection 124 to an analog-to-digital converter (ADC) 126. The ADC 126 digitizes the sensor signal and provides a digital control signal via connection 118. The control signal on connection 118 controls the variable fluidic impedance 104 so that desired fluid flow and pressure is maintained at the output of the column 106.

In the electrical circuit representation 100, a constant flow across the column 106 can be obtained by varying the impedance 104, such that the total impedance of the system is constant. Similarly, a constant flow through the column 106 can be maintained by varying the pressure provided by the pressure source 102, with the pressure increasing with an increase in the total impedance of the system.

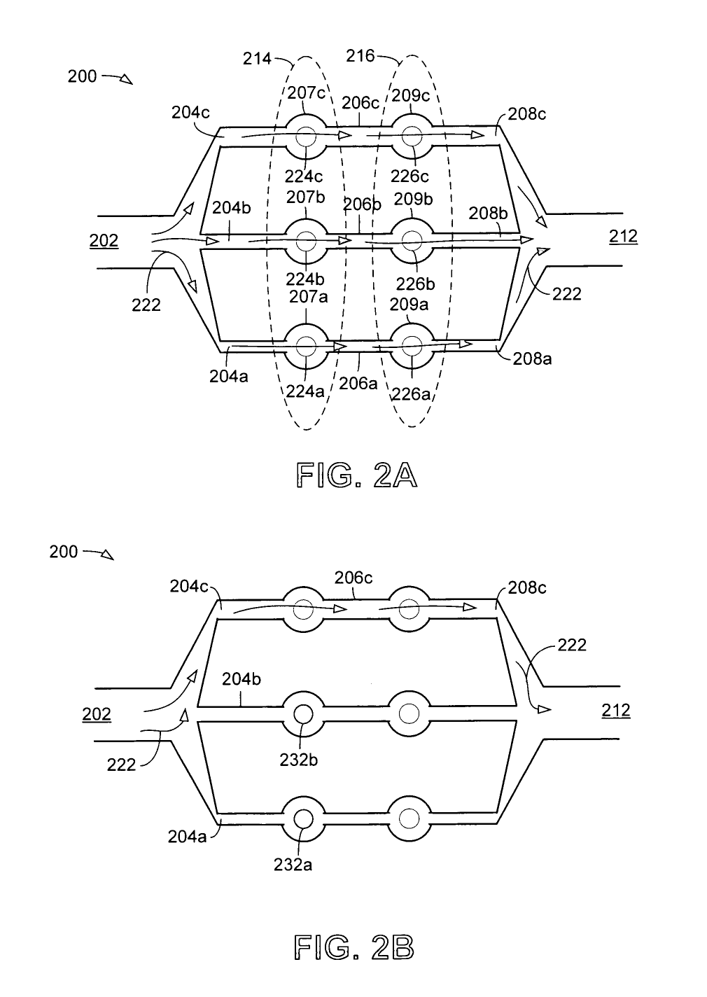

FIG. 2A is a schematic diagram illustrating a fluidic circuit 200. The fluidic circuit 200 is the mechanical analog of the variable fluidic impedance 104 of FIG. 1. The fluidic circuit 200 includes a microfluidic channel 202. In this example, the microfluidic channel 202 branches into three channel portions 204a, 204b and 204c. However, other configurations and numbers of channel portions are possible. Each of the channels 204a, 204b and 204c has a cross-sectional area that is different from each other channel portion. The flow through each channel portion is typically Poiseuille in that the pressure drop in each channel portion is inversely proportional to the fourth power of the hydraulic diameter of each channel.

In this example, the impedance of the channel portion 204b is twice the impedance of the channel portion 204a. Similarly, the impedance of the channel portion 204c is twice the impedance of the channel portion 204b. However, other impedances of the channel portions 204a, 204b and 204c are possible. The example illustrated in FIG. 2A uses three channel portions for simplicity of illustration. When using three channel portions each having different impedances, the equivalent of three bit accuracy is provided for controlling the flow of fluid through the fluidic circuit 200.

The channel portion 204a includes a fluid cavity 207a. The fluid cavity 207a includes a heating element 224a. The fluid cavity 207a is coupled to a channel portion 206a, which is also coupled to another fluid cavity 209a. The fluid cavity 209a includes a heating element 226a. The fluid cavity 209a is coupled to a channel portion 208a. In this example, the channel portions 206a and 208a have a similar cross-sectional area as the channel portion 204a. However, each of the channel portions 204a, 206a and 208a may have different cross-sectional area. The channel portion 208a is coupled to a microfluidic channel 212. The flow of liquid 222 through the channel portions 204a, 206a and 208a and the fluid cavities 207a and 209a is indicated using the arrows.

The channel portion 204b includes a fluid cavity 207b. The fluid cavity 207b includes a heating element 224b. The fluid cavity 207b is coupled to a channel portion 206b, which is also coupled to another fluid cavity 209b. The fluid cavity 209b includes a heating element 226b. The fluid cavity 209b is coupled to a channel portion 208b. As shown, the channel portions 206b and 208b have a similar cross-sectional area as the channel portion 204b, but other cross section areas are possible. The channel portion 208b is coupled to a microfluidic channel 212. The flow of liquid 222 through the channel portions 204b, 206b and 208b and the fluid cavities 207b and 209b is indicated using the arrows.

The channel portion 204c includes a fluid cavity 207c. The fluid cavity 207c includes a heating element 224c. The fluid cavity 207c is coupled to a channel portion 209c, which is also coupled to another fluid cavity 209c. The fluid cavity 209c includes a heating element 226c. The fluid cavity 209c is coupled to a channel portion 208c. The channel portions 206c and 208c have a similar cross-sectional area as the channel portion 204c. The channel portion 208c is coupled to a microfluidic channel 212. The flow of liquid 222 through the channel portions 204c, 206c and 208c and the fluid cavities 207c and 209c is indicated using the arrows.

Each of the heating elements 224a, 224b, 224c, 226a, 226b and 226c may comprise a thin film resistive material over which one or more dielectric and cavitation barrier layers may be located. The heating elements 224a, 224b, 224c, 226a, 226b and 226c can be joule heating elements. The heating elements 224a, 224b and 224c are primary heating elements 214 and the heating elements 226a, 226b and 226c are secondary heating elements 216. The secondary heating elements 216 may be used if one or more of the primary heating elements fail. When activated, the heating elements heat the liquid passing through the respective fluid cavities and boil the liquid, thus causing a bubble to form in the fluid cavity. The presence of the bubble in the fluid cavity impedes the flow of the liquid in the respective channel portion, thus modulating and controlling the flow of liquid in the respective channel portion. By controlling the heating elements 224a, 224b and 224c in each of the fluid cavities 207a, 207b and 207c, the flow of fluid from the microfluidic channel 202 to the microfluidic channel 212 can be precisely controlled. Similarly, by controlling the heating elements 226a, 226b and 226c in each of the fluid cavities 209a, 209b and 209c, the flow of fluid from the microfluidic channel 202 to the microfluidic channel 212 can be precisely controlled.

FIG. 2B is a schematic diagram illustrating the fluidic circuit 200 of FIG. 2A in which fluid flow is controlled by the heating elements. In FIG. 2B, the heating elements 224a and 224b are activated, causing a bubble to be generated in the respective cavities 207a and 207b. The presence of bubbles 232a and 232b, in the respective cavities 207a and 207b is indicated by the black dot in each cavity 207a and 207b. The bubble 232a prevents the flow of fluid through the channel portion 204a and the bubble 232b prevents the flow of fluid through the channel portion 204b. Accordingly, the fluid 222 is directed through the channel portions 204c, 206c and 208c into the microfluidic channel 212. Typically, at least one channel portion 204a, 204b or 204c should remain at least partially open, as bubbles are limited in the amount of pressure they can support before being driven downstream. Further, because the amount of fluid pressure and flow that can be modulated by a single bubble is limited, multiple stages of primary heating elements 214 and secondary heating elements 216 can be provided to allow larger pressure drops between the microfluidic channel 202 and the microfluidic channel 212.

In one embodiment, the heating elements are rapidly cycled on and off, at a frequency of, for example, a few to many kilohertz (kHz) or greater. The time period for cycling the heating elements is shorter than the “time constant” of the fluidic circuit. The time constant of the fluidic circuit 200 will typically be at least an order of magnitude longer than 1/frequency, where 1/frequency is the time period for cycling the heating elements. Using the electrical analog of the fluidic circuit, the fluidic circuit 200 has the equivalent of electrical capacitance, resistance and inductance, which affects the time constant of the circuit. By varying the duty cycle of the heating element, and therefore the generation of a bubble, it is possible to create a controllable average flow through the circuit 200. The averaging effect is because the fluidic circuit cannot respond at the same frequency at which the bubbles are created by the heating elements. This concept is analogous to pulse width modulation (PWM) in an electronic circuit. Using liquid chromatography as an example, the feedback electronics 116 (FIG. 1) monitors the flow through the column 106 (FIG. 1) and modifies the duty cycle of the heating elements of FIGS. 2A and 2B to obtain the desired flow through the fluidic circuit 200.

In another example, the heating elements in a microfluidic channel may be activated quasi-statically. In this example, each of the bubbles are generated so that the size of the bubble remains constant. The term quasi-static activation of the heating elements refers to switching at a frequency that allows the fluidic circuit 200 to settle into a steady-state operation between switching events. In this embodiment, a number of different heating elements generate a number of corresponding bubbles so that flow in a fluidic channel can be modulated to achieve a desired pressure and flow in the channel. In the context of a chemical analysis application such as liquid chromatography, a number of heating elements can be used in the fluidic network to continuously or periodically modulate the flow of fluid through a packed column based on changing flow conditions in the column during a chromatographic analysis.

The temperature at which the fluid in the fluidic circuit boils is dependent on a number of factors including the pressure of the fluid in the circuit. The pressure of the fluid at each cavity 207 is also dependent on the location of the cavity 207 with respect to the pressure source 102 (FIG. 1). The vaporization curves of most liquids have similar shape. The vapor pressure steadily increase as the temperature increases. A good approach is to find a mathematical model for the pressure increase as a function of temperature. Experiments showed that the pressure P, enthalpy of vaporization, ΔHᵥₐₚ, and temperature T are related according to the formula:
P=A exp (−ΔHᵥₐₚ/R T),
where R (=8.3145 J mol⁻¹ K⁻¹) is the gas constant and A is an approximation. This is known as the Clausius-Clapeyron equation.

The Clausius-Clapeyron equation allows the vapor pressure at another temperature to be estimated if the vapor pressure is known at some temperature, and if the enthalpy of vaporization is known.

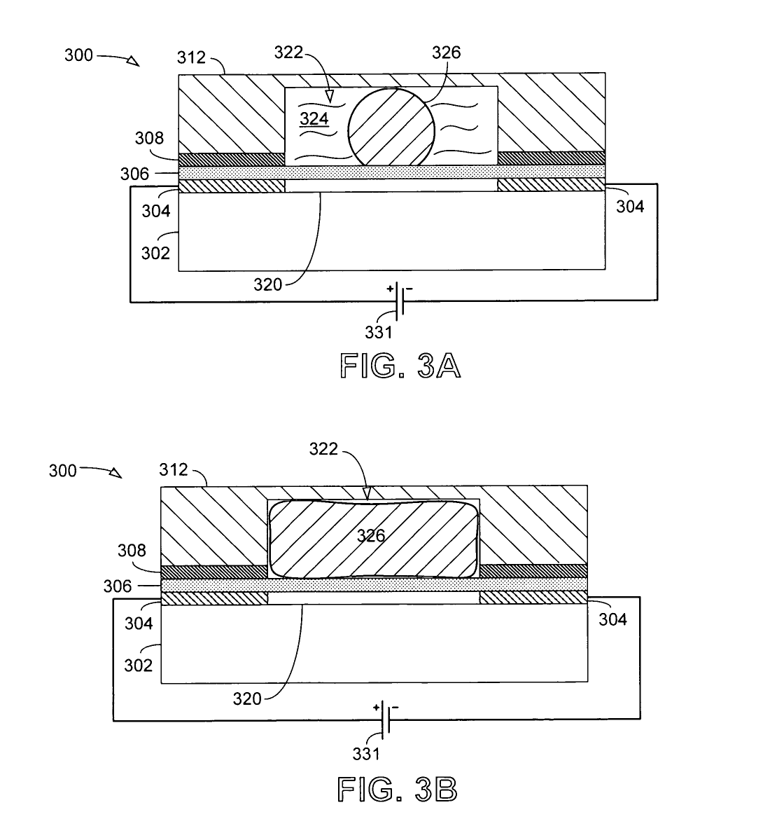

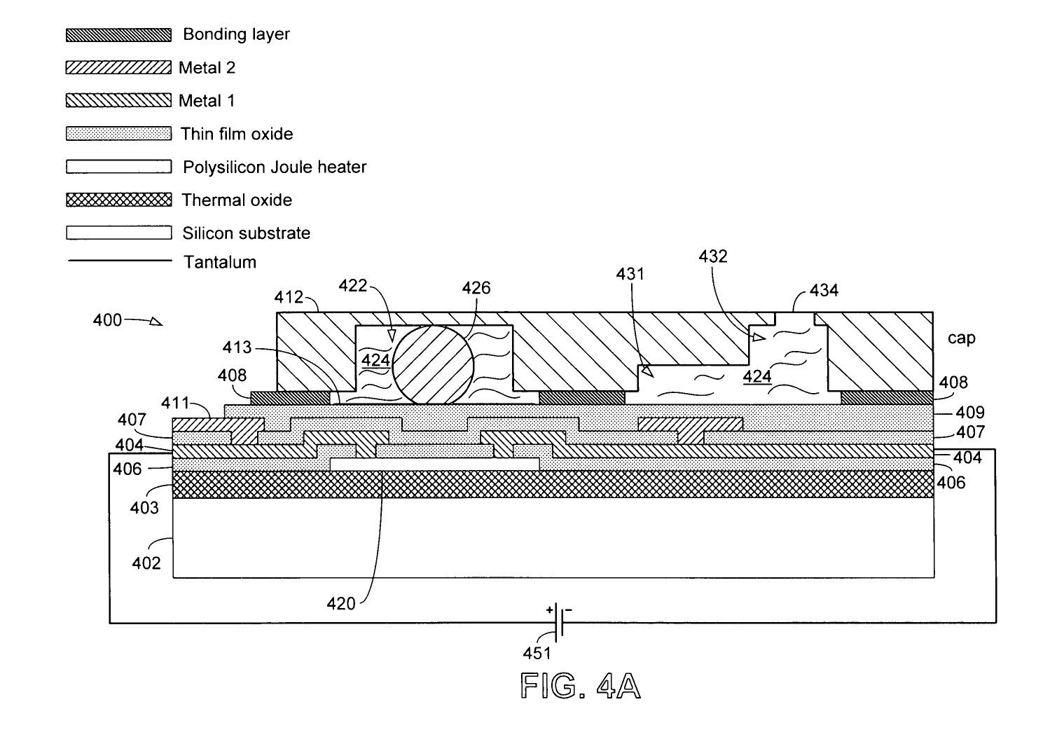

FIG. 3A is a schematic diagram illustrating a cross-sectional view of the fluid cavity 207a of FIG. 2A and FIG. 2B. However, the cross-sectional view of FIG. 3A is representative of any of the fluid cavities of FIG. 2A and FIG. 2B. The cross-sectional view of FIG. 3A is intended to show the basic elements of the fluid cavity of FIG. 2A and FIG. 2B and the generation of a bubble in the fluid cavity. A heating element 320 is provided over a silicon substrate 302. However, other materials such as glass, silicon carbide, or sapphire may be used for the substrate 302. Metal contacts 304 are formed over the substrate 302 and in electrical contact with the heating element 302. In this example, the heating element 302 is a resistive heating element, but other heating technologies could be used. A layer 306 of oxide is formed over the metal 304 and the heating element 320. The oxide can be, for example, silicon dioxide (SiO₂), or another dielectric material such as silicon nitride (SiN), silicon carbide (SiC), or another insulator applied as a thin film. The oxide 306 insulates the metal 304 and the heating element 320 from the liquid 324 in the fluid cavity 322.

A layer of bonding material 308 is applied over the oxide 306 to bond a cap 312 in place over the oxide 306. In an embodiment, the cap 312 can be a glass material, such as Pyrex. Alternatively, the bonding material may be applied to both the oxide 306 and the cap 312 which are then placed together. In an exemplary embodiment, the bonding material can be gold thermo-compression bonding, gold-silicon eutectic bonding, gold-indium bonding, glass frit bonding, anodic bonding, in which case the bonding material includes a layer of amorphous silicon applied to the cap 312, or another bonding technique that is known in the art. The cap 312 and the surface of the layer 306 form a microfluidic cavity 322 that contains a liquid 324. The liquid 324 can be any liquid, provided the liquid is compatible with the materials of construction. In the case of liquid chromatography, the liquid 324 can be a mixture of water and a solvent, such as acetonitrile. In this example, the flow of the liquid 324 is into or out of the plane of the page.

A power source 331, illustrated for simplicity as a battery, is coupled to the heating element 320 through the metal contacts 304. A control circuit is omitted from FIG. 3A for simplicity. However, a control circuit, such as the feedback electronics 116 (FIG. 1) may control the operation of the heating element 320. When electrical current is applied to the heating element 320, the heating element 320 heats and boils the liquid 324 in the vicinity of the heating element 320, thus forming a bubble 326. As the bubble grows, the flow of fluid in the microfluidic cavity 322 is impeded.

FIG. 3B is a schematic diagram illustrating a cross-sectional view of the fluid cavity of FIG. 3A after generation of the bubble. While the bubble 326 is illustrated a circular, the bubble 326 will generally conform to the shape of the microfluidic cavity 322. Further, it is possible that the bubble 326 will not completely fill the microfluidic cavity 322, displacing all the liquid. Instead, it is possible that liquid will be able to flow past portions of the bubble 326, particularly in the corners of the microfluidic cavity 322. In such a situation, the bubble 326 does not completely stop the flow of liquid 324 in the microfluidic cavity 322, but instead, impedes the flow of the liquid through the microfluidic cavity 322. By carefully controlling the operation of the heating element 320, a bubble 326 can be generated and maintained that modulates and controls the flow of liquid in the microfluidic cavity 322.

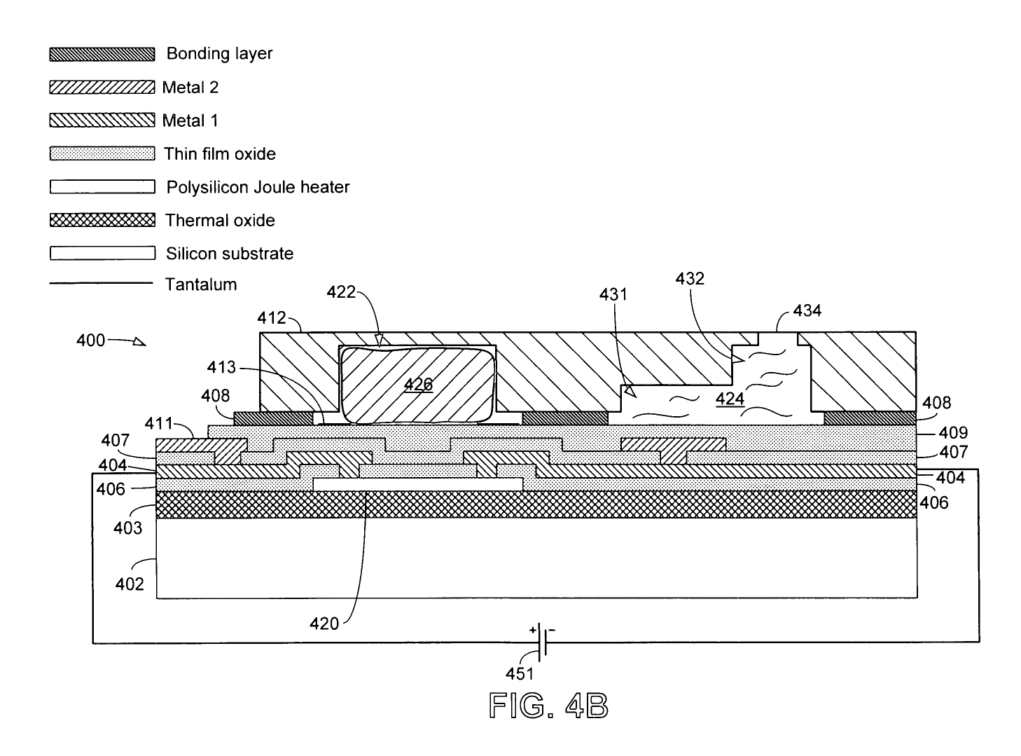

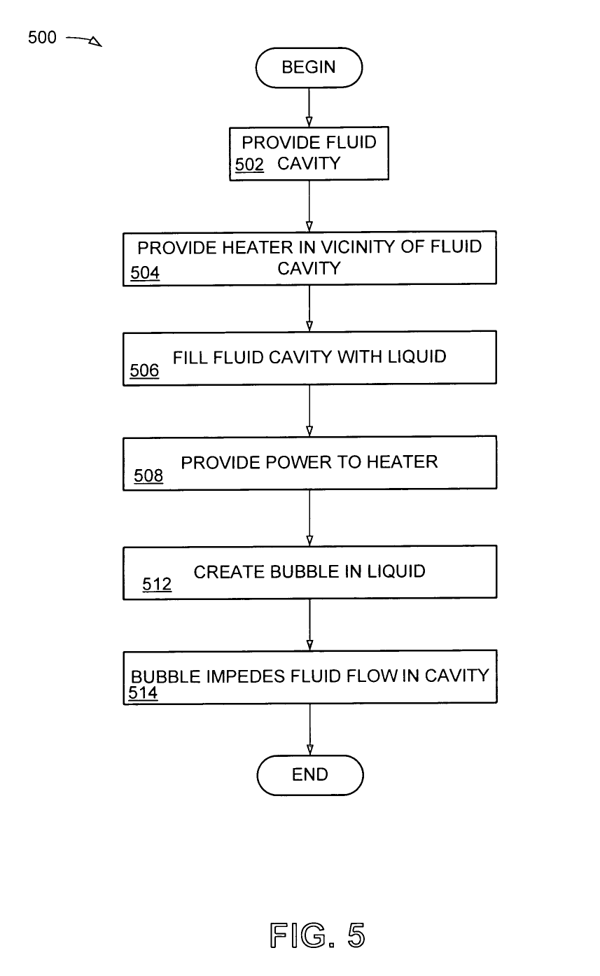

FIG. 4A is a detailed schematic diagram illustrating a cross-sectional view of the fluid cavity 207a of FIG. 2A and FIG. 2B including a switch element 400. A silicon substrate 402 is provided over which a thermal oxide layer 403 is formed. However, other materials, such as glass, silicon carbide and sapphire may be used for the substrate 402. In one embodiment, thermal oxide layer 403 comprises silicon dioxide (SiO₂). However, other material can be used for the layer 403.

A heating element 420 is provided over a portion of the thermal oxide layer 403. In this example, the heating element 420 is a resistive heating element, but other heating technologies could be used. A layer of oxide 406 is formed over portions of the thermal oxide 403 and the heating element 420 as shown. The oxide material of the layer 406 is similar to the oxide material 306 described above. The oxide can be, for example, silicon oxide (SiO₂), or another dielectric material such as silicon nitride (SiN), silicon carbide (SiC), or another insulator applied as a thin film.

A layer 404 of a first metal material is formed over the oxide layer 406 and in contact with the heating element 420. The layer 404 of metal forms the electrical contacts to the heating element 420. The metal of the layer 404 can be, for example, aluminum, gold, or another stable conductive material. A layer 407 of oxide is formed over the layer 404. A layer 411 of a second metal material is formed over portions of the layer 404 of the first metal material and portions of the oxide layer 407. The layer 411 of metal forms another layer of electrical interconnect.

Another layer 409 of oxide is formed over the layer 411 of metal and layer 407 of oxide material. The material of the oxide layer 409 is similar to the material of the oxide layer 407. The oxide 409 insulates the metal 404, metal 411 and the heating element 420 from the liquid 424 in the fluid cavity 422. A layer 413 of tantalum may optionally be located over the oxide layer 306 to act as a cavitation barrier.

A layer of bonding material 408 is applied over portions of the oxide layer 409 to bond a cap 412 in place over the oxide layer 409. The cap 412 is similar to the cap 312. Alternatively, the bonding material may be applied to both the oxide layer 409 and the cap 412 which are then placed together. In an exemplary embodiment, the bonding material can be gold thermo-compression bonding, gold-silicon eutectic bonding, gold-indium bonding, glass frit bonding, anodic bonding, in which case the bonding material includes a layer of amorphous silicon applied to the cap 312, or another bonding technique that is known in the art. The cap 412 and the surface of the oxide layer 409 form a microfluidic cavity 422 that contains a liquid 424. The liquid 424 can be any liquid. In the case of liquid chromatography, the liquid 424 can be a mixture of water and a solvent, such as acetonitrile. In this example, the flow of the liquid 424 is into or out of the plane of the page.

A power source 451, illustrated for simplicity as a battery, is coupled to the heating element 420 through the metal 404. A control circuit is omitted from FIG. 4A for simplicity. However, a control circuit, such as the feedback electronics 116 (FIG. 1) may control the operation of the heating element 420. When electrical current is applied to the heating element 420, the heating element 420 heats and boils the liquid 424 in the vicinity of the heating element 420, thus forming a bubble 426. As the bubble grows, the flow of fluid in the microfluidic cavity 422 is impeded.

FIG. 4B is a schematic diagram illustrating a cross-sectional view of the fluid cavity of FIG. 4A after generation of the bubble. While the bubble 426 is illustrated a circular, the bubble 426 may conform to the shape of the microfluidic cavity 422. Further, it is possible that the bubble 426 will not completely fill the microfluidic cavity 422. Instead, it is possible that fluid will be able to flow past portions of the bubble 426. In such a situation, the bubble 426 does not totally stop the flow of liquid 424 in the microfluidic cavity 422, but instead, impedes the flow of the liquid. By carefully controlling the operation of the heating element 420, a bubble 426 can be generated that modulates and controls the flow of liquid in the microfluidic cavity 422.

The cap 412 and the layer 409 also define a shallow channel 431 and a deep channel 432. The shallow channel 431 and the deep channel 432 also contain fluid 424. The shallow channel 431 provides a higher impedance fluid connection, and the deep channel 432 provides a lower impedance fluid connection. The through etch 434 is for the fluidic input and output to and from the switch element 400.

FIG. 5 is a flowchart 500 describing a method for controlling fluid flow in a microfluidic circuit. In block 502 a fluid cavity is provided. In block 504 a heating element is provided in the vicinity of the fluid cavity. In block 506, the fluid cavity is filled with fluid. In block 508, a power source provides power to the heating element. In block 512, the heating element boils the liquid in the fluid cavity, thus creating a bubble in the fluid cavity. In block 514, the bubble impedes fluid flow in the fluid cavity.

This disclosure describes embodiments in accordance with the invention in detail. However, it is to be understood that the invention defined by the appended claims is not limited to the precise embodiments described.

What is claimed is:

1. A system for controlling fluid flow in a microfluidic circuit, comprising:
at least one microfluidic channel;
a heating element adjacent the at least one microfluidic channel, wherein when activated, the heating element boils liquid in the at least one microfluidic channel; and
a bubble in the microfluidic channel, the bubble modulating fluid flow in the microfluidic channel.

2. The system of claim 1, in which the bubble at least partially fills the microfluidic channel.

3. The system of claim 1, further comprising a plurality of microfluidic channels arranged in parallel.

4. The system of claim 3, in which the plurality of microfluidic channels are of differing cross-sectional area.

5. The system of claim 4, in which each microfluidic channel comprises at least one heating element.

6. The system of claim 5, in which each microfluidic channel comprises a primary heating element and a secondary heating element.

7. The system of claim 5, further comprising feedback electronics, the feedback electronics configured to monitor fluid flow in the microfluidic channel and control the fluid flow by selectively activating the at least one heating element.

8. A method for controlling fluid flow in a microfluidic circuit, comprising:
providing a fluid cavity having fluid;
providing a heating element in the vicinity of the fluid cavity;
providing a power source to the heating element; and
heating the fluid such that the fluid boils, thus creating a bubble in the fluid cavity.

9. The method of claim 8, further comprising using the bubble to modulate fluid flow in a microfluidic channel associated with the fluid cavity.

10. The method of claim 8, in which a plurality of microfluidic channels arranged in parallel.

11. The method of claim 10, in which the plurality of microfluidic channels are of differing cross-sectional area.

12. The method of claim 11, in which each microfluidic channel comprises at least one heating element.

13. The method of claim 12, in which each microfluidic channel comprises a primary heating element and a secondary heating element.

14. The method of claim 12, further comprising monitoring fluid flow in the microfluidic channel and controlling the fluid flow by selectively activating the at least one heating element.

15. A system for controlling fluid flow in a microfluidic circuit, comprising:
at least one microfluidic channel;
a heating element adjacent the at least one microfluidic channel, wherein when activated, the heating element boils liquid in the at least one microfluidic channel forming a bubble in the at least one microfluidic channel, the bubble modulating fluid flow in the microfluidic channel.

16. The system of claim 15, further comprising a plurality of microfluidic channels arranged in parallel.

17. The system of claim 16, in which the plurality of microfluidic channels are of differing cross-sectional area.

18. The system of claim 17, in which each microfluidic channel comprises at least one heating element.

19. The system of claim 18, in which each microfluidic channel comprises a primary heating element and a secondary heating element.

20. The system of claim 18, further comprising feedback electronics, the feedback electronics configured to monitor fluid flow in the microfluidic channel and control the fluid flow by selectively activating the at least one heating element.
